(19) United States
(12) Patent Application Publication
(10) Pub. No.: US 2023/0112448 A1
(43) Pub. Date: Apr. 13, 2023

(54) COMPUTATIONAL STORAGE DRIVE USING FPGA IMPLEMENTED INTERFACE

(71) Applicant: Seagate Technology LLC, Fremont, CA (US)

(72) Inventors: Hemantkumar Vitthalrao MANE, Pune (IN); Niranjan Anant POL, Pune (IN); Nahoosh Hemchandra MANDLIK, Pune (IN); Avinash Suresh PISAL, Pune (IN)

(21) Appl. No.: 17/563,999

(22) Filed: Dec. 28, 2021

(30) Foreign Application Priority Data
Oct. 12, 2021 (IN) 202121046547

(51) Int. Cl. G06F 13/16

(52) U.S. Cl. CPC G06F 13/1668

(57) ABSTRACT

A dynamically reconfigurable computational storage drive (CSD) that facilitates parallel data management functionality for a plurality of associated memory devices. The CSD includes an FPGA device that is dynamically reconfigurable during operation of the CSD to provide one or more data management functionality. The CSD interfaces with a plurality of storage controllers for parallel data management functionality applied to a corresponding plurality of memory devices. The CSD may be provided as a rack-mounted device or a storage appliance for dynamic provision of data management functionality to data in a storage system comprising the CSD.

### BACKGROUND

Data storage systems often implement a plurality of media devices to provide a desired storage capacity for the data storage system. For example, data storage systems may be implemented in data centers or other large scale computing platforms where a large storage capacity is required. In this regard, data storage systems may include rack-based installations of storage drives in which storage drives may be engaged with a backplane provided in a rack-based mounting solution. Accordingly, standardized rack sizes, backplane connectors, and other infrastructure has been developed to support efficient and interoperable operation of storage drives in data storage systems. In other examples, a storage appliance may be deployed within a network or at a given network node to facilitate persistent storage of data.

In addition, computational storage devices have been proposed where computational resources may be provided at or near a storage drive to execute certain functionality with respect to data of a data storage system. While such computational resources have been proposed for inclusion in a storage drive, a number of limitations exist for such solutions. For example, proposed approaches to computational storage devices typically include pre-programmed and static functionality that is embedded into a drive's computational capacity. Such functions are predetermined and cannot be reconfigured once the drive is deployed into a storage system. Thus, such computational storage drives are often implemented in a very particular application in which a static, repeatable function is applied to data. Moreover, such computational storage resources may rely on static connectors and communications protocols to facilitate data communication with the storage drive. As such, computational storage drives provide little flexibility to provide dynamic and adaptable functionality with respect to the functions executed by the computational storage drive.

### SUMMARY

The present disclosure generally relates to a storage device. The storage device includes an FPGA device comprising a programmable FPGA fabric. The FPGA device is in operative communication with a host device. The storage device also includes a plurality of storage controllers that are each in operative communication with a respective one of a plurality of memory devices for non-volatile storage of data in the plurality of memory devices. Each of the plurality of storage controllers are in operative communication with the FPGA device. The storage device also includes a storage resource, accessible by the FPGA, that stores one or more hardware execution functions for configuration of a data operation performed by the FPGA on data received by the FPGA device exchanged between the FPGA device and the plurality of storage controllers. The FPGA fabric is dynamically reconfigurable using the one or more hardware execution functions during operation of the storage device to provide one or more data operations on data at the FPGA device exchanged between the FPGA device and the storage controllers. The one or more data operations comprise parallel operation of each of the plurality of storage controllers of the storage device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 is a schematic view of an example storage system.

FIG. 2 is a schematic view of an example of a programmable FPGA device.

FIG. 3 is a schematic view of an example storage system implemented using computational storage devices having a programmable FPGA device.

FIG. 4 illustrates example operations for a computational storage devices having a programmable FPGA device.

FIG. 5 is a schematic view of an example of a rack-based storage system having computational storage devices having a programmable FPGA device.

FIG. 6 is a schematic view of a storage system including an FPGA device for use in a rack-based storage system.

FIG. 7 is a schematic view of an example of a storage appliance having computational storage devices having a programmable FPGA device.

FIG. 8 is a schematic view of an example of an FPGA device operating in an in-line configuration.

FIG. 9 is a schematic view of an example of an FPGA device operating in an in-line configuration.

FIG. 10 is a schematic view of an example of a computing device that may be used to execute aspects of the present disclosure.

### DETAILED DESCRIPTIONS

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope of the invention as defined by the claims.

It has been proposed to incorporate computational resources into storage drives to facilitate some computational capacity at a storage drive to allow for some functionality to be applied to data stored locally at a storage drive with inbuilt computational resources. Such computational storage approaches have traditionally provided static, preconfigured functionality, often executed using limited computational resources. For example, such functionality was provided by means that imparted limits to the functionality that could be applied to data and could not be changed once a storage drive was deployed into a storage system. In turn, computational storage drives are often used in limited, niche roles in which the nature of the functionality applied to the data by the computational storage resources is known prior to drive provisioning and is static for the lifetime of the storage system. Such limitations present drawbacks for more widespread adoption of computational storage devices in contexts where dynamic functionality is required.

The present disclosure is generally related to a storage system that includes a storage drive with one or more memory devices for persistent storage of data. Specifically, the present disclosure contemplates a dynamically configurable computational storage device (CSD) that may include or interface with a plurality of memory devices (e.g., to provide parallel data management functionality to the plurality of memory devices). The CSD may include programmable hardware that facilitates dynamic and configurable functionality that may be applied to data in a storage system. The programmable hardware of the CSD may interface with a plurality of memory devices, that may each include dedicates storage controllers. The dedicated storage controllers may allow for parallel operations to be applied relative to each of the plurality of memory devices of the CSD. In turn, the programmable hardware device may provide for parallel data management functions applied to a plurality of storage drives in communication with the programmable hardware. In still other examples, the programmable hardware device may facilitate internal or peer-to-peer data operations without intervention of a host device.

In examples described herein, the programmable hardware device may comprise a field programmable gate array (FPGA) or other programmable hardware device. While reference is made to an FPGA or an FPGA device, it may be appreciated that other programmable hardware devices may be provided without limitation. The FPGA device may include an input/output (IO) module that may facilitate operative communication between the FPGA device and a host. The FPGA device includes configurable hardware such as an FPGA fabric that may be configurable to provide hardware engines for application of one or more data management functions to data. The FPGA device may also facilitate a compute complex that enables one or more software engines for application of functionality to data. As will be described in greater detail below, the hardware and/or software engines facilitated by the FPGA device may allow for execution of data management functionality relative to data in the storage system so as to facilitate computational storage by the CSD including the FPGA device. For instance, the FPGA device described herein may facilitate dynamic configuration of an interface protocol for interfacing between a host device and the plurality of storage drives in operative communication with the FPGA device. Thus, an interface protocol may be reconfigured during operation of the CSD without having to reboot or restart the CSD and without reconfiguration of physical connections. However, in other examples, the data management functionality may include data acceleration and/or data flow management without limitation.

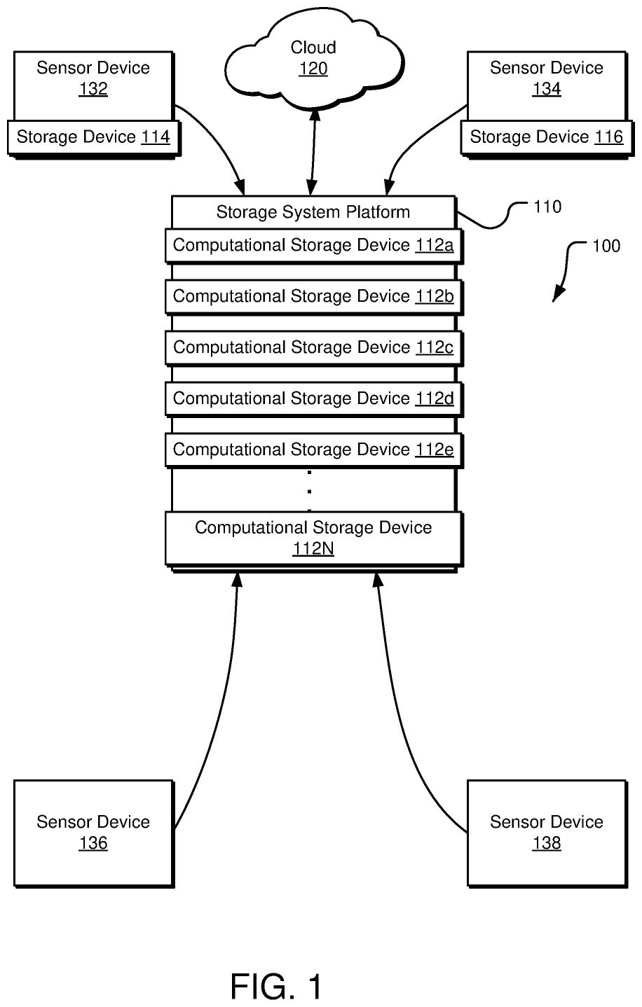

FIG. 1 depicts an example storage system 100. The storage system 100 includes a storage system platform 110. The storage system platform 110 may be in operative communication with a plurality of sensor devices 132-138. The sensor devices 132-138 may generate or transmit data to the storage system platform 110. The transmission of data to the storage system platform 110 may be by way of direct connection or via a network connection between the sensor devices 132-138 and the storage system platform 110. In this regard, sensor device 132, sensor device 134, sensor device 136, and sensor device 138 may each be any appropriate sensor or device to generate or relay data to the storage system platform 110. While the sensor devices 132-138 are shown in FIG. 1, this is for illustrative purposes and additional or fewer sensor devices or other sources of data may be provided without limitation.

Sensor device 132 may include a local storage device 114 for storage of data locally at the sensor device 132. Also, sensor device 134 may also include a local storage device 116. For sensor devices 132 and 134 having local storage devices 114 and 116, respectively, data may be generated by the respective sensor device and stored locally at the local storage device, offloaded to the storage system platform 110, duplicated between the local storage device and the storage system platform 110, or split between the local storage device in the storage system platform 110. In this regard, the storage device 114 and/or storage device 116 may be provided as a storage appliance deployed locally at the sensor device 132 and 132, respectively. Alternatively, sensor device 132 and/or 134 may comprise integrated storage devices and/or a CSD as described in greater detail below.

The storage system platform 110 may be in operative communication with a cloud environment 120. The cloud environment 120 may provide additional storage and/or computational resources in addition to those described below provided by the CSDs described herein. In addition, the cloud environment 120 may facilitate networked access by a host device (not shown in FIG. 1) to the storage system platform 110 for interface therewith. In other examples, a host may be directly connected to the storage system platform 110.

In traditional storage systems, data is typically transmitted to a cloud environment or to a host device, which exclusively applies functionality to the data. That is, traditionally the storage system provides persistent data storage with limited, static or no ability to provide any computational resources for data management functionality. As may be appreciated, the requirement to transmit data to a host from a storage system may involve extensive network overhead associated with the transport of data to and from such a cloud environment or host device in order to apply data management functions to the data.

As such, the storage system 100 of the present disclosure may include one or more CSDs in the storage system 100. For example, the storage system platform 110 may comprise a plurality of CSDs 112a-112N. While CSD 112a, CSD 112b, CSD 112c, CSD 112d, CSD 112e, , CSD 112N are shown in FIG. 1, it may be appreciated that additional or fewer CSDs could be provided with the storage system platform 110 without limitation. Furthermore, while not shown in FIG. 1, the storage system platform 110 may also include computational storage processors and/or other devices that may or may not include storage drives. The CSDs 112a-112N may be provided in a rack environment such that the computational storage drives 112 may be engaged with a backplane to allow for expansion, swapability, and other features common to rack-based storage drive mounting. Also, as noted above, the storage devices 114 and/or 116 disposed at edge devices, such as the sensor devices 132 and 134, may also comprise CSDs as described in greater detail below. In this regard, the CSDs described herein may comprise a storage appliance deployed at an edge node of a network. As may be appreciated in the disclosure below, a CSD may include an FPGA device that provides configurable functionality to apply data management functionality to data stored in or retrieved from the storage drives of the data storage system 100.

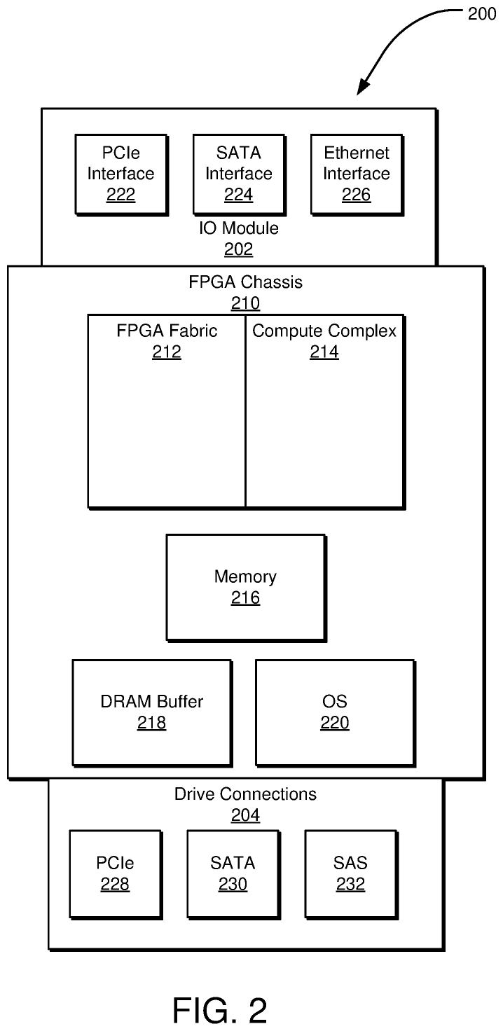

For example, FIG. 2 depicts an example FPGA device 200. The FPGA device 200 may include an IO module 202. The IO module 202 may include one or more standard connectors or ports for interfacing with a host device. As described in greater detail below, these connectors or ports may include, for example, ethernet ports or connectors, USB ports or connectors, SATA ports or connectors, PCIe ports or connectors, standardized backplane ports or connectors, or the like. For purposes of illustration, a PCIe interface 222, a SATA interface 224, and an ethernet interface 226 are depicted in FIG. 2. However, additional for fewer ports or connectors may be provided without limitation. Moreover, more than one of a given type of interface may also be provided without limitation.

The FPGA device 200 may also include one or more storage drive connections 204. In turn, one or more storage drives may be connected to the FPGA device 200 via the drive connections 204 to establish operative communication between the FPGA device 210 and the one or more storage drives (not shown in FIG. 2). The drive connections 204 may include a plurality of types of connectors or ports commonly utilized for different kinds of storage drives including, for example, ethernet, SATA, SAS, and PCIe ports or connectors. This may allow a wide variety of standardized storage drive form factors to be engaged with the FPGA device 200 via the drive connections 204. Accordingly, while a PCIe drive connector 228, a SATA drive connector 230, and a SAS drive connector 232 are shown in FIG. 2, other connectors or ports may be provided without limitation.

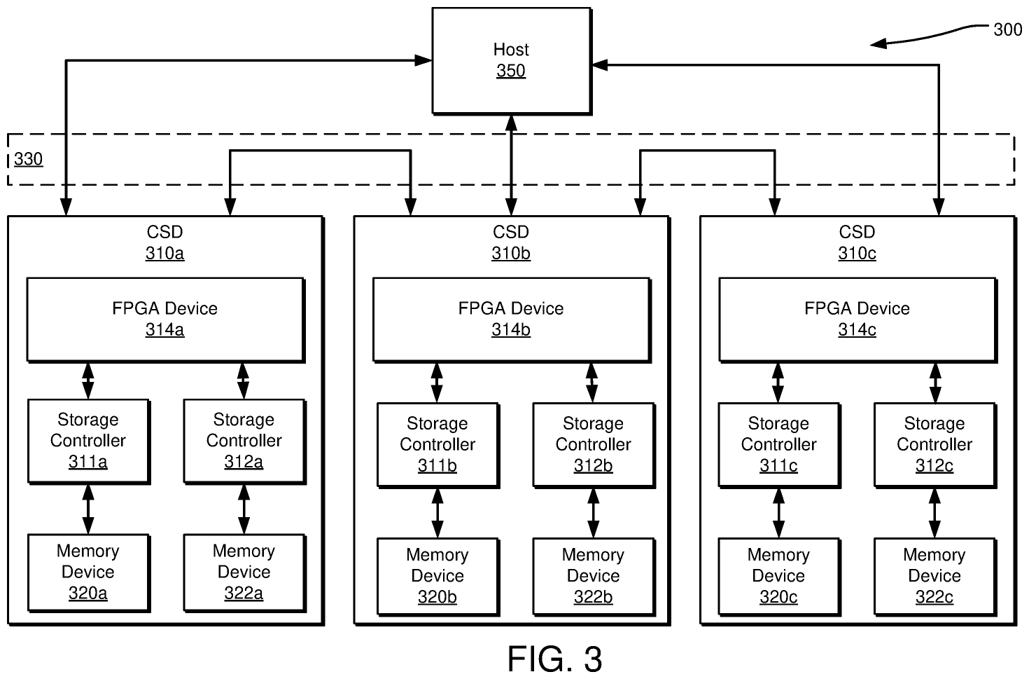

The drive connections 204 may be simultaneously support connectivity to a plurality of storage drives. Connected storage drives may each comprise storage controllers capable of controlling IO operations of the storage drive as shown in greater detail in FIG. 3. In turn, the FPGA device 200 may facilitate parallel operations of a plurality of connected storage drives. Such parallel operations may include data management functionality, read operations, write operations, erase operations, or any other operation to be performed relative to the storage drives in operative communication with the FPGA device 200. The FPGA device 200 may be configured to present the plurality of storage drives connected to the FPGA device 200 to a host as a single storage resource or a plurality of storage resources. This may allow for provisioning or tiering of the storage resources provided by the storage drives connected to the FPGA device 200. In an alternative embodiment, the FPGA device 200 may be provided as an integrated unit with the FPGA device 200 being integrated into an enclosure with one or more storage drives. In this regard, rather than having a drive connections 204 to provide swappable or interchangeable engagement between the FPGA device 200 and a storage drive, the storage drive may be fixedly connected to an FPGA device 200. In this case, the FPGA device 200 may be integrated with one or more storage drives in a common enclosed chassis.

In any regard, the FPGA device 200 and/or connected or integrated storage drives may have a form factor that is similar to or the same as a standard rack-mounted storage drive. That is, the FPGA device 200 may be provided in a common enclosure with a plurality of storage drives. Such an enclosure may comprise a standard rack-mount unit size so as to be provided in a rack-based environment such as a datacenter or the like. This may be true even when the FPGA device 200 is operatively engaged with a plurality of storage drives. As such, the FPGA device 200 and storage drives connected thereto may be deployed into a standardized rack slot for engagement with a backplane chassis of a storage system. For instance, the IO module 202 may interface with the backplane chassis of the storage system. In this regard, the FPGA device 200 may be used to provide configurable computational functionality to a storage drive in a form factor that facilitates engagement of the FPGA device 200 and associated storage drives in a standardized rack space of a storage system as a rack-mounted CSD. Alternatively, the FPGA device 200 may be provided in a common enclosure with a plurality of storage drives in the form of a storage appliance including the CSD.

The FPGA device 200 may also include computational resources capable of executing the data management functionality of a CSD. The computational resources may be provided in forms such as an FPGA fabric 212 and/or a compute complex 214. The FPGA fabric 212 may be configurable during operation of the storage system without having to reboot or power-cycle the FPGA device 200. For example, the FPGA fabric 212 may be configured based on a bitstream provided to the FPGA fabric 212. A memory 216 of the FPGA device 200 may comprise a bitstream storage area in which one or more configuration bitstreams for the FPGA fabric 212 are stored. A plurality of bitstreams may be stored in the bitstream storage area for providing different configurations to dynamically reconfigure the FPGA fabric 212. Alternatively, a portion of memory provided by a connected storage drive (not shown in FIG. 2) may include a bitstream storage area that may comprise configuration bitstreams for configuration of the FPGA fabric. The FPGA fabric 212 may be specifically configured to facilitate one or more hardware engines for application of functionality to data stored at a locally connected storage drive, a peer storage drive in a storage system, or via the IO module 202. Such functionality may include dynamically reconfiguration a communication protocol used to communicate data to or from storage drive as described in more detail below.

The compute complex 214 may comprise one or more embedded processors such as central processing units (CPUs) and/or graphical processing units (GPUs). The compute complex 214 may include either bare metal or operating system mounted applications that may be executed by the compute complex 214. In this regard, the compute complex 214 may comprise dedicated memory or may facilitate the memory 216 to store configuration instructions for execution by the embedded processor(s) of the compute complex 214. As such, the FPGA device 200 may also execute an operating system 220 that may be mounted via the compute complex 214 to run various online or offline applications on data stored in the storage drives connected to the FPGA device 200. In this regard, the compute complex 214 may be specifically configured to facilitate one or more software engines for application of functionality to data retrieved from a locally connected storage drive or via the IO module 202.

The FPGA device 200 also includes a DRAM buffer that may be used as a staging buffer of the FPGA device 200 to facilitate ingress or egress of data with respect to the FPGA device 200. In addition, as described in greater detail below, the DRAM buffer may be used in peer-to-peer data movement between storage drives in a storage system as managed by the FPGA device 200 of one or more coordinating storage drives without involving the host (e.g., without involving host memory buffer copies).

The FPGA fabric 212 may be configured to perform a number of different data management functionalities in relation to the data storage in a connected storage drive. Examples of such data management functionality may generally include interface management, data flow management, and/or data acceleration.

FIG. 3 illustrates one example of a storage system 300 that includes a plurality of CSDs 310 according to the present disclosure. In FIG. 3, a host device 350 may be in operative communication with the plurality of CSDs 310, which include CSD 310a, CSD 310b, and CSD 310c. The host device 350 may be in operative communication with the CSDs 310 by way of one or more network devices 330, which are generally depicted as a unitary block, but could actually comprise multiple devices at multiple locations to facilitate a network interface between the host device 350 and the CSDs 310. In this regard, the network devices 330 may include one or more switches, routers, gateways, or other networking devices including wide area network devices such that the host device 350 may be remotely located from one or more of the CSDs 310. As may also be appreciated, the plurality of CSDs 310 may directly communicate with each other via the network devices 330 without communication to the host device 350. While CSDs 310a-310C are depicted in the example of FIG. 3, it may be appreciated that more or fewer CSDs 310 be provided without limitation.

With specific reference to CSD 310a, the CSD 310a may include an FPGA device 314a. The FPGA device 314a may be provided according to any of the examples described herein. In this regard, the FPGA device 314a may be operative to apply one or more data management functions to data locally at the CSD 310a or to data that is received from another device such as another CSD 310b or 310c or the host device 350. The FPGA device 314a may include a programmable FPGA fabric and/or computer complex to provide data management functionality as one or more hardware engines and/or one or more software engines as described in greater detail below. The data management functionality may include any one or more of data interface management, data flow management, or data acceleration as will be described in greater detail below.

The FPGA device 314a may be in operative communication with each of a storage controller 311a and a storage controller 312a. Storage controller 311a may be in operative communication with a memory device 320a to provide control of IO functions performed relative to the memory device 320a. Storage controller 312a may be in operative communication with a memory device 322a to provide control of IO functions performed relative to the memory device 322a. In this regard, the storage controller 311a and memory device 320a may provide storage capability in parallel with the storage controller 312a and memory device 322a. As each of the storage controller 311a and the storage controller 322a are in communication with the FPGA device 314a, the data management functionality provided by the FPGA device 314a may be applied in parallel to data retrieved from or stored to either one of memory device 320a or 322a. Memory device 320a and memory device 322a may comprise any appropriate type of memory device including a solid-state memory device, a hard disk drive, or other storage devices without limitation. The memory device 320a may be the same type of device as memory device 322a or the memory devices 320a and 322a may provide different memory types that may include different characteristics for data storage and retrieval.

While not described in detail, CSD 310b may have a similar structure as CSD 310a such that an FPGA device 314b may provide parallel data management functionality through communication with a storage controller 310b/memory device 320b and storage controller 312b/memory device 322b. Similarly, CSD 310c may have a similar structure as CSD 310a such that an FPGA device 314c may provide parallel data management functionality through communication with a storage controller 311c/memory device 320c and storage controller 312c/memory device 322c.

In the storage system 300, the host device 350 may communicate directly with a given CSD 310 in order to conduct or control data management functionality in relation to data stored to or retrieved from any of memory devices 320 or 322 in storage system 300. This may include the host device 350 issuing commands to a given CSD 310 such that the FPGA device 314 is operative to perform one or more data operations on data stored to retrieved from the memory device 320 or 322 in response to the host device 350 command.

Alternatively, because the CSDs 310 may be in direct communication with each other, the FPGA devices 314 of the system 300 may coordinate to perform data management functionality without involvement (e.g., control or commands) of the host device 350. As will be described in greater detail below, this may include one or more data management operations including data interface management, data flow management, and/or data acceleration performed on data stored to or retrieved from the memory devices 320/322. Such data management functionality may be coordinated amongst the FPGA devices 314 in the absence of control by the host device 350. In one example described in more detail below, this may include providing tiering of the memory device resources, providing a RAID configuration amongst the memory device resources, or other coordinated operation. In addition, memory device resources across the plurality of CSDs 310 may be presented to the host device 350 as a consolidated or unitary storage volume with coordination of storage of data in individual memory devices 320/322 coordinated by the FPGA devices 314 in the absence of direction from the host device 350. This may include parallel operations such that a given FPGA device 314 may issue simultaneous commands to a plurality of memory devices 320/322 stored within the given CSD 310 for parallel operations.

As further described in detail below, the CSDs 310 may be provided in a number of forms including rack-based storage devices, storage appliances, or other forms of enclosures that include the FPGA device, storage controller 311, storage controller 312, memory device 320, and memory device 322.

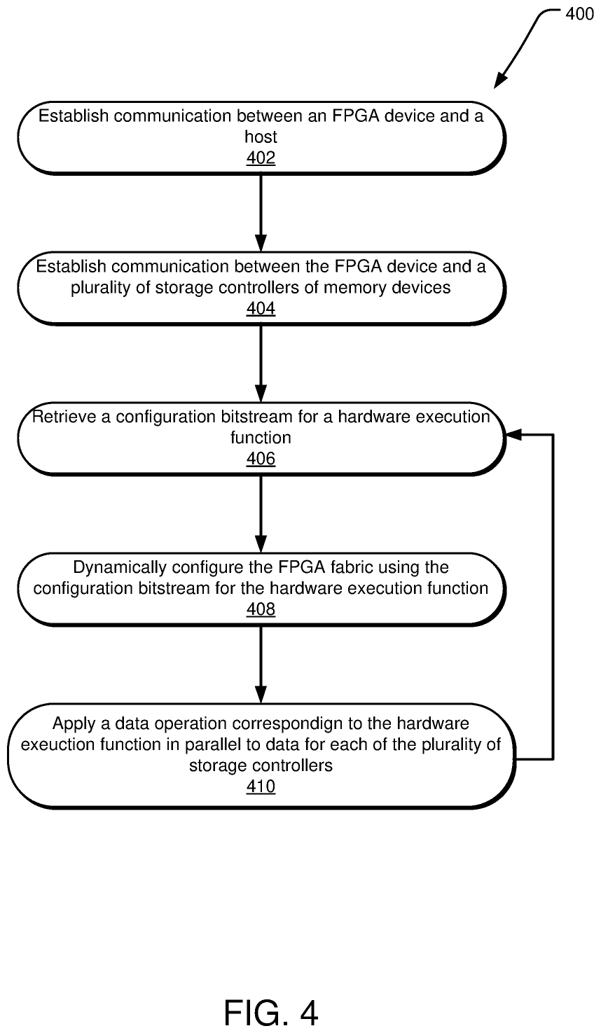

With further reference to FIG. 4, example operations 400 for operation of a CSD according to the present disclosure are described. The operations 400 may include an establishing operation 402 in which communication is established between an FPGA device and a host device. Another establishing operation 404 may include establishing communication between the FPGA device and a plurality of storage controllers of memory devices associated with the FPGA device. Specifically, the establishing operation 404 may include an operation within a given enclosure of a CSD in which the FPGA device of the CSD establishes communication with the plurality of storage controllers corresponding to the plurality of memory devices provided within the enclosure of the CSD.

A retrieving operation 406 may include retrieving a configuration bitstream for a hardware execution function. The hardware execution function may include data management functionality of any kind described herein. The configuration bitstream may be stored in a bitstream storage area locally on FPGA device, within a memory device of the CSD, or within a memory device of a peer CSD (that is, another CSD in operative communication with the FPGA device being configured).

The operations 400 further include a configuration operation 408 that includes dynamically configuring the FPGA fabric of the FPGA device using the configuration bitstream to define the hardware execution function desired. In turn, an applying operation 410 may include applying a data operation corresponding to the hardware execution function to data. Specifically, the applying operation 410 may include parallel application of the data operation corresponding to the hardware execution function to data relative both of the storage controllers for the memory devices of the CSD in parallel. The operations 400 may be iterative such that the operations returned to the retrieving operation 406 such that additional or different data operations corresponding to hardware execution functions may be retrieved and configured for application of data in parallel to a plurality of memory devices of a CSD.

With returned reference to FIG. 2, the FPGA fabric 212 may be configured (e.g., by a bitstream as described above) to provide a particular data interface functionality for communication of data to or from a storage drive associated with the FPGA device 200 (e.g., connected to one of the drive connections 204). As noted above, storage drives are traditionally statically configured to utilize a given type of connector and communication protocol that comprise an interface. For instance, a storage drive may be a SATA, SAS, NAS, PCIe, or other drive type that is visible to the host in connection with the particular interface for the storage drive. Each of these various interfaces may have different characteristics such as bandwidth, queue command depth, duplex characteristic, data transfer speeds, power consumption, etc. In traditional approaches such characteristics must be analyzed and a particular static interface type chosen based on an application to maximize the characteristics required for a given context.

However, in the present disclosure, the FPGA fabric 212 may be dynamically configured during operation of the storage device 200 to support different interfaces for associated storage drives. Thus, the interface for the storage resources of the CSD may be modified during operation of the CSD to leverage advantages of a given interface. Such configuration may be dynamically provided at the FPGA fabric 212. In addition, the FPGA fabric 212 may function to reassign pins of a connector of the IO module 202 and/or drive connections 204 to support the change in interface. Thus, an interface may be dynamically configured by the FPGA fabric 212 such that the communication protocol used to communicate with a storage drive is changed along with the pin assignments for a connector. As such, the storage drive and/or connection to a host or peer storage drive via the IO module 202 may be dynamically changed without power-cycling the FPGA device 200 and without changing the physical connection between the components of the system.

Also, the FPGA fabric 212 may also be dynamically configured to perform one or more particular data flow management functionalities with respect to data in addition to or alternatively to the data interface management described above. The data flow management may be performed by the FPGA fabric 212 on data received by the FPGA fabric 212 prior to storage on an associated (e.g., connected) storage drive via a drive connections 204 or may be retrieved from a connected storage drive for application of the data management functionality to the data. The data flow management functionality may include in-line encryption of data by the FPGA fabric 212. Additionally or alternatively, the data flow management functionality may provide for data compression of data by the FPGA fabric 212. Further still, the data flow management functionality may provide data provenance information including hashing or signature matching by the FPGA fabric 212. Such data flow management may be provided by one or more hardware engines facilitated by the configured FPGA fabric for execution in relation to data to be stored on an associated storage drive or from data retrieved from a locally associated storage drive. Such data flow management may be provided regardless of the particular communication interface utilized to comminate data to or from a storage drive using the FPGA device 200.

A data acceleration management functionality of the FPGA fabric 212 may also be configured by providing a specific bitstream for configuration of the FPGA fabric 212. As an example, a data acceleration function may include application of artificial intelligence or machine learning analytics that may include execution of an artificial intelligence (AI) acceleration engine by the FPGA fabric 212. In this regard, the AI acceleration engine may be executed by the configured FPGA fabric 212 to provide some artificial intelligence or machine learning functionality in relation to data to be stored in a connected storage drive, that is retrieved locally from a connected storage drive, or received from a peer storage drive (e.g., without host intervention). In one example, the FPGA fabric 212 may be programmed to perform the acceleration engine as one or more hardware engines. Such data acceleration management function may be provided regardless of the particular communication interface utilized to comminate data to or from a storage drive using the FPGA device 200.

The AI acceleration engine of the FPGA device 200 may provide an application programming interface (API) that may be callable by a host. In this regard, rather than the host calling for retrieval of data from the storage drive for execution of acceleration functionality on the data and returning transformed or new data resulting from the acceleration engine to the storage drive for storage, the API of the FPGA device 200 may be called by the host such that the resulting data provided after execution of the acceleration engine on data stored locally at the storage drive may be returned by the FPGA device 200 in response to the API call by the host. In this regard, the computational functionality associated with the acceleration engine (e.g., application of the AI functionality to the locally stored data) may be applied locally by the FPGA fabric 212 such that only the resulting data resulting from the acceleration engine application to the data is returned to the host.

Accordingly, it may be appreciated that the FPGA fabric 212 may be specifically configured as one or more hardware engines to perform one or more of the functionalities noted above including interface management, data flow management, or acceleration management. However, other configurable functionality may be provided by an FPGA fabric 212 without limitation such that other computational functionality associated with data accessible by the FPGA device 200 may be provided without limitation.

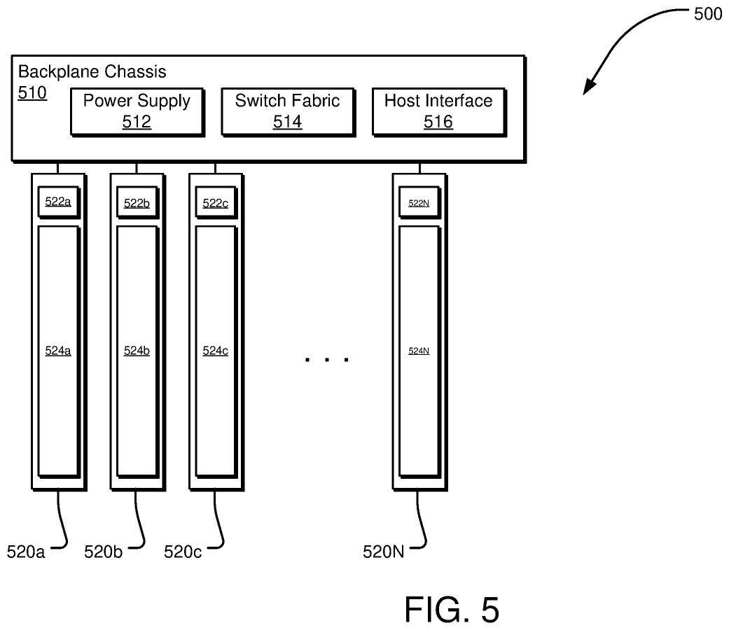

As noted above, an FPGA device 200 may be incorporated into a rack-mounted CSD or as a CSD of a storage appliance. FIG. 5 depicts an example of CSDs 520 according to the present disclosure deployed in a rack-based storage system platform 500. The storage system platform 500 includes a backplane chassis 510. A plurality of CSDs 520a, 520b, 520c, . . . ,520N may be provided in operative communication with the backplane chassis 510. The backplane chassis 510 may include shared resources for the storage system platform 500 including, for example, a power supply 512, switch fabric 514, and/or a host interface 516. Other devices or modules may be provided at the backplane chassis 510 without limitation. In addition, the plurality of CSDs 520a-520N may be provided via corresponding connectors 526a-526N. The connectors 526 may be standardized connector interfaces to provide operative communication between corresponding CSDs 520 and the backplane chassis 510.

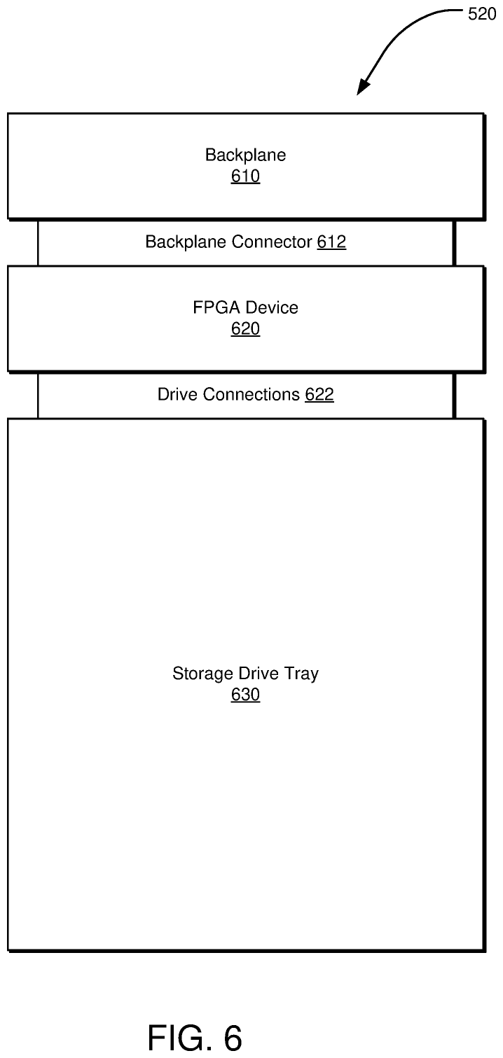

Continuing the rack-based example of FIG. 5, a CSD 520 is depicted in more detail in FIG. 6 that may be specifically adapted to provide an integrated CSD device having an FPGA device 620 and memory devices integrated into a common enclosure or chassis such that the CSD 520 may be utilized in a standard rack-based storage system. The CSD 520 may have a backplane connector 612 for engagement with a standardized or proprietary backplane 610 of a server rack. The backplane connector 612 may incorporate any of the foregoing discussion of the IO module described in other examples. The CSD 520 may also include an FPGA device 620 according to any of the discussion provided herein.

The FPGA device 600 may include one or more drive connections 622. The drive connections 622 maybe arranged relative to a storage drive tray 630 for supportive engagement of one or more memory devices or drives. The storage drive tray 630 and drive connections 622 may be configured to support simultaneous connectivity to a plurality of standardized storage drives or other memory devices. For example, the storage drive tray 630 may include an upper surface and a lower surface. The upper surface may provide support to a first storage drive that may be connected to the FPGA device 620 via a first drive connection 622. The lower surface may provide support to a second storage drive that may be connected to the FPGA device 620 via a second drive connection 622. The drive connections 622 and drive tray 630 may simultaneously support a plurality of the same type of drive or different types of drive configurations.

As described above, the FPGA device 620 may be configured to present to a host the plurality of storage drives connected to the FPGA device 620 as a single storage resource or a plurality of storage resources. This may allow for provisioning or tiering of the storage resources provided by the storage drives connected to the FPGA device 620. In an alternative embodiment, the FPGA device 620 may be provided as an integrated unit with one or more storage drives. In this regard, rather than having drive connections 622 that provide swappable or interchangeable engagement between an FPGA device 620 and a storage drive, the storage drive may be fixedly provided with an FPGA device 600. In this case, the FPGA device 600 may be provided with one or more storage drives in a common enclosed chassis.

In any regard, the FPGA device 600 and/or connected or integrated storage drives may have a form factor that is similar to or the same as a standard rack-mounted storage drive. This may be true even when the FPGA device 600 is operatively engaged with a plurality of storage drives. As such, the FPGA device 600 and storage drives connected thereto may be deployed into a standardized rack slot for engagement with a backplane chassis of a storage system. In this regard, the FPGA device 600 may be used to provide configurable computational functionality to a storage drive in a form factor that facilitates engagement of the FPGA device 600 and associated storage drives in a standardized rack space of a storage system.

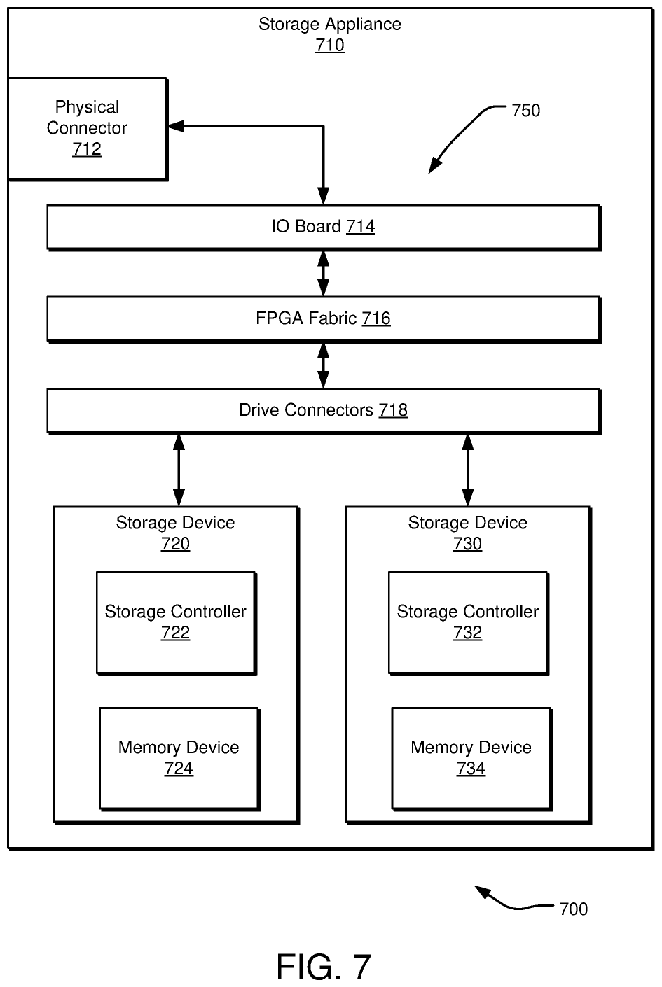

In contrast to the rack-based form factor described in relation to FIGS. 5 and 6, FIG. 7 depicts another example of a CSD 700 that is provided as a storage appliance 710. Storage appliance 710 may generally include an FPGA device 750 that includes an I/O module 714, FPGA fabric 716, and drive connectors 718 is generally described above. The I/O module 714 may be connected to a physical connector 712 that may allow for physical connections to be made to the storage appliance 710. The physical connector 712 may include a number of different types of connectors to support a variety of different interfaces such as those described above. In addition, the drive connectors 718 may be in operative communication with the plurality of storage devices 720 and 730. Storage device 720 may include a storage controller 722 and a memory device 724. Storage device 730 may include a storage controller 732 and a memory device 734. In this regard, the FPGA device 750 may be utilized to perform any of the foregoing functionality including data interface reconfiguration for operations to be performed relative to the storage device 720 and/or seven storage device 730. As may be appreciated, the storage appliance 710 may include the physical connectors 712, the FPGA device 750, storage device 720, and storage device 730 in an enclosure such that the storage appliance 710 may be deployed at a given location to provide a CSD with inbuilt functionality and data storage. That is, the storage appliance 710 may be deployed outside a rack-based infrastructure of a datacenter or the like. For example, the storage appliance 710 may be deployed an edge of a network to provide storage capacity and data management functionality according to the disclosure provided above.

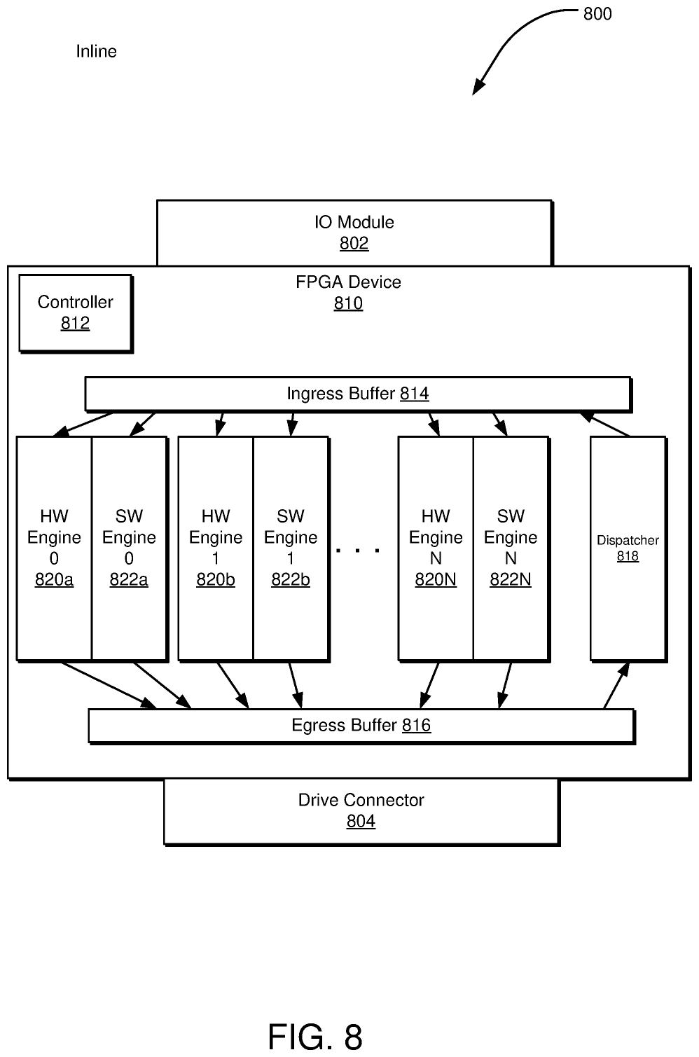

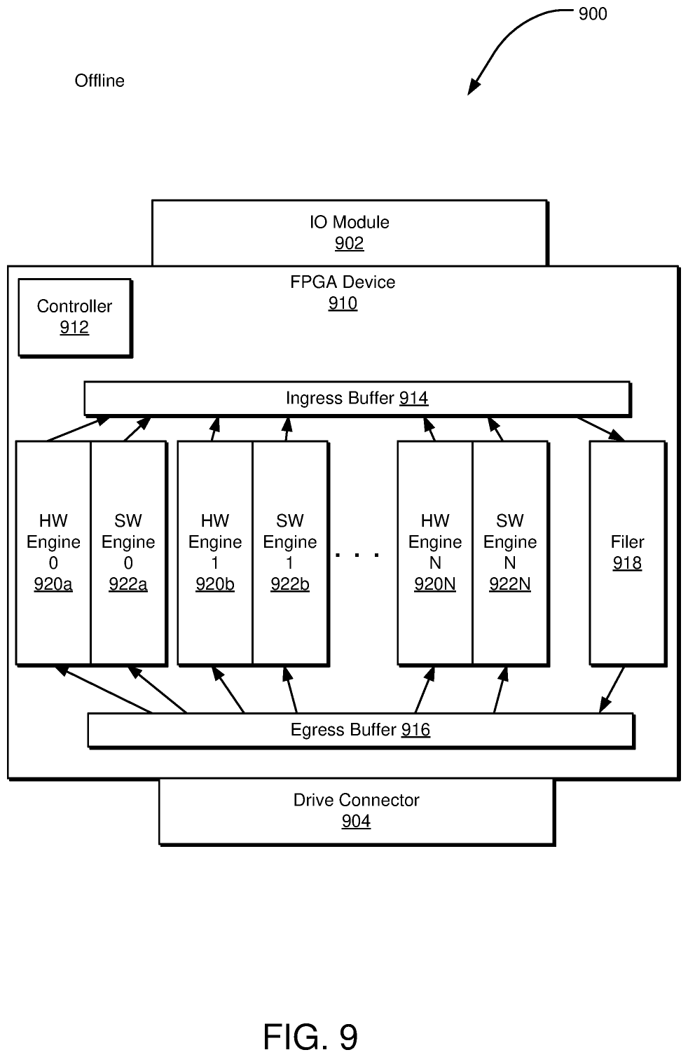

FIGS. 8 and 9 generally depict two potential contexts for utilization of an FPGA device by providing either in-line functionality as described in FIG. 8 or providing off-line functionality as shown in FIG. 9

In FIG. 8, an FPGA device 810 is shown that includes an IO module 802 and drive connectors 804 according to any of the foregoing description. In addition, the FPGA device 810 includes a controller module 812 which may include one or more processors and/or memory that may be used for control functionality of the FPGA device 800 including, for example, issuing bit streams for configuration of the FPGA complex and/or compute complex of the FPGA device 810.

In the depicted example of FIG. 8, a plurality of hardware engines 820 and software engines 822 may be correspondingly paired to act on data traversing the FPGA device 800. Specifically, hardware engine 0 820a, hardware engine 1, 820b, . . . , hardware engine N 820N may be provided in corresponding pairs with software engine 0 822a, software engine 1 822b, . . . , software engine N 822N. Each respective hardware engine may correspond to a hardware engine executed by an FPGA fabric of the FPGA device 800. Each respective software engine 822 may correspond to a software engine be executed by a compute complex of the FPGA device 800. Each corresponding hardware engine 820 and software engine 822 pair may provide functionality applied to data received from an ingress buffer 814 provided by a DRAM buffer as described in relation to FIG. 2. In this regard, as data flows from the IO module 802 to the ingress buffer 814, the ingress buffer 814 may direct data to respective ones of the hardware engines 820 or software engines 822 for application of the respective functionality provided by the corresponding hardware or software engine. In turn, the hardware engine 820 or software engine 822 processing the data may provide process data to egress buffer 816, which may coordinate writing the data to an associated storage drive via the drive connector 804. As may be appreciated, each of the hardware engines 820 and software engines 822 may provide one or more corresponding functionalities such as interface management, data flow management, and/or data acceleration management as described in any of the foregoing examples. As such, various ones of the hardware engines 820 may execute the same functionality or different hardware engines 820 may provide different corresponding functionalities chosen from those described above or others. In this regard, the example shown in FIG. 8 may be referred to as an in-line operation as data that is being provided for writing to the storage drives associated with the FPGA device 800 is the data upon which the functionality from the hardware engines 820 and software engines 822 may be applied. Optionally, the FPGA device 800 may include a dispatcher 818 that may receive data from the egress buffer 816 and provide the data to the ingress buffer 814. That is, dispatcher 818 may provide resulting data to a host, or cloud environment in response to the data being stored and/or processed by the FPGA device 800.

Alternatively, with reference to FIG. 9, an FPGA device 900 may be provided for off-line operation. In this regard, the FPGA device 900 includes similar components is that described with respect to FIG. 8 including an IO module 902, an ingress buffer 914, hardware engines 920, software engines 922, and egress buffer 916, a drive connector 904, and a controller 912. However, in contrast to the FPGA device 800 shown in FIG. 8 in which functionality may be applied to data received at the FPGA device 800 for storage in an associated storage drive, the FPGA device 900 may receive data stored locally at an associated storage drive from the egress buffer 916 such that functionality from the one or more hardware engine 920 or software engines 922 are applied to data that has been stored locally at an associated drive the FPGA device 900. This may be in response to an instruction from a host device requesting certain functionality be applied to locally stored data (e.g., through APIs described above) or may be locally coordinated by the controller 912. In any regard, resulting data generated by the application of the one or more hardware engines 920 or software engine 922 may be provided to a host device or cloud environment via the ingress buffer 914. That is, the FPGA device 900 may perform an off-line compute on locally stored data of associated storage drives with resulting data being provided from the FPGA device 900 to a host or cloud environment. In addition, a filer 918 may be provided for simultaneously storing incoming data received at the ingress buffer 914 and provided to the egress buffer 916 providing to an associated storage drive by the FPGA device 900.

In relation such off-line operations, it may be appreciated that an FPGA device according to the present disclosure may provide sufficient computational capacity to allow for coordinated operation across a plurality of storage drives and/or peer FPGA devices provided with such storage drives. Such coordinated functionality may include peer-to-peer execution of any one or more of the foregoing functionalities including interface management, data flow management, or data acceleration management.

With returned reference to FIG. 3, further explanation of such peer-to-peer coordination of functionality provided by FPGA devices 314 in a coordinating storage system 300 is illustrated. Each CSD 310 may operate in either an in-line operation configuration such as that depicted in FIG. 8, or an off-line operation such as that depicted in FIG. 9. In relation to off-line operation, the functionality applied to data by a given one of the FPGA devices 314 may not be strictly limited to application functionality to data stored in a corresponding memory device 320/322 of the given FPGA device 314. Rather, the FPGA devices 314a-314c may coordinate to provide associated functionality to data stored in a peer CSD 310. In this regard, the FPGA devices 314a-314c may facilitate in communication via the network devices 330.

As an example, a given FPGA device 314a may advertise excess bandwidth for a given functionality capability over the network devices 330 to others of the FPGA devices 314b-314c. In turn, another FPGA device (e.g., 314c) may retrieve data from a corresponding associated memory device 320c or 322c and communicate the retrieve data over the network devices 330 to FPGA device 314a which may apply functionality to such data and return the data or transformed data to the FPGA device 314c via the network devices 330 for storage in the memory device 320c or 322c. Of note, such peer-to-peer coordination to provide functionality may be coordinated amongst the FPGA devices 314 executing locally in the storage system 300 without the intervention or involvement of the host device 350. As such, the respective FPGA devices 314 illustrated in FIG. 3 may coordinate in a peer-to-peer fashion to provide peer to peer execution of any the functionality described above to an associated memory device or a peer CSD in the storage system 300.

One particular example of such peer-to-peer coordination may allow for load-balancing data storage across the respective CSDs 310 of the storage system 300. For instance, one or more of the FPGA devices 314 may execute a load balancing system as a hardware engine provided by a configured FPGA fabric of the FPGA devices 314 or as a software engine provided by a compute complex of the FPGA devices 314. As such, the load balancing system may be encoded as hardware functions of the FPGA fabric and/or computer executable code of the computer complex. In this regard, a given FPGA device 314a of the storage system 300 may receive information from one or more of the peer CSDs 310 of the storage system 300 including information regarding load and/or storage capacity of the given drives. In turn, the load balancing system executed by the FPGA device 314a may determine a load or storage capacity of the other storage devices in the system 300. The load balancing system may in turn reconfigure the FPGA fabric of an FPGA device 314a in which the load balancing system is executed and or a FPGA fabric of a peer FPGA device 314b or 314c to rebalance storage amongst the plurality of CSDs 310. Of note, such rebalancing may occur within the given FPGA devices 314 and memory devices 320 or 320 the storage system 300 without involvement of an external host.

In certain implementations, the rebalancing of data storage amongst of the plurality of CSDs 310 of the storage system 300 may facilitate tiering of the memory devices 320/322. Such tiering may provide multiple tiers of data storage amongst the CSDs 310. The tiering of the CSDs 310 may be executed locally between a given FPGA device 314 and a respective memory device 320/322 associated therewith or such storage tiering may be expanded across a plurality of CSDs 310 and involve the coordination of a plurality of FPGA devices 314 to realize the data storage tiering. For example, multiple tiers may be dedicated amongst the CSDs 310 to facilitate hot data storage cold data storage. In addition, as described above, the FPGA devices 314 may include a configurable FPGA fabric that may allow for dynamic configuration of interface of one or more of the drives. In this regard, in addition to providing multiple data tiers, the respective tiers may be configured with a corresponding interface as provided by the configurable FPGA fabric of one or more of the FPGA devices 314 and the storage system 300.

In turn, a highly flexible storage system 300 may be realized in which the FPGA devices 314a-314c may coordinate in a peer-to-peer fashion to provide distributed data functionality for either in-line data processing or off-line data processing across the plurality of CSDs 310a-310c. In addition, such peer-to-peer provision of data management functionality (e.g., including interface management, data flow management, data acceleration management, tiering, data rebalancing, etc.) may be facilitated amongst the CSDs 310 of the data storage system 300 without involvement of the host device 350. In this regard, the data storage system 300 may be presented logically to the host device 350 as a data storage volume with the various data functionality being coordinated and facilitated at the storage system 300 by way of the computational resources provided by the FPGA devices 314.

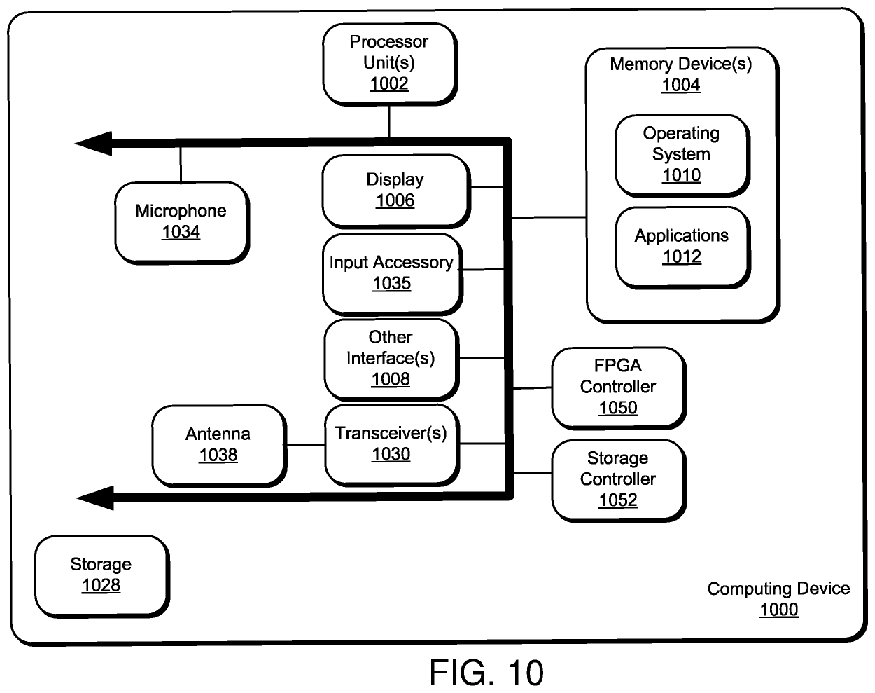

FIG. 10 illustrates an example schematic of a computing device 1000 suitable for implementing aspects of the disclosed technology including an FPGA controller 1050 and/or a storage controller 1052 as described above. The computing device 1000 includes one or more processor unit(s) 1002, memory 1004, a display 1006, and other interfaces 1008 (e.g., buttons). The memory 1004 generally includes both volatile memory (e.g., RAM) and non-volatile memory (e.g., flash memory). An operating system 1010, such as the Microsoft Windows® operating system, the Apple macOS operating system, or the Linux operating system, resides in the memory 1004 and is executed by the processor unit(s) 1002, although it should be understood that other operating systems may be employed.

One or more applications 1012 are loaded in the memory 1004 and executed on the operating system 1010 by the processor unit(s) 1002. Applications 1012 may receive input from various input local devices such as a microphone 1034, input accessory 1035 (e.g., keypad, mouse, stylus, touchpad, joystick, instrument mounted input, or the like). Additionally, the applications 1012 may receive input from one or more remote devices such as remotely-located smart devices by communicating with such devices over a wired or wireless network using more communication transceivers 1030 and an antenna 1038 to provide network connectivity (e.g., a mobile phone network, Wi-Fi®, Bluetooth®). The computing device 1000 may also include various other components, such as a positioning system (e.g., a global positioning satellite transceiver), one or more accelerometers, one or more cameras, an audio interface (e.g., the microphone 1034, an audio amplifier and speaker and/or audio jack), and storage devices 1028. Other configurations may also be employed.

The computing device 1000 further includes a power supply 1016, which is powered by one or more batteries or other power sources and which provides power to other components of the computing device 1000. The power supply 1016 may also be connected to an external power source (not shown) that overrides or recharges the built-in batteries or other power sources.

In an example implementation, the computing device 1000 comprises hardware and/or software embodied by instructions stored in the memory 1004 and/or the storage devices 1028 and processed by the processor unit(s) 1002. The memory 1004 may be the memory of a host device or of an accessory that couples to the host. Additionally or alternatively, the computing device 1000 may comprise one or more field programmable gate arrays (FPGAs), application specific integrated circuits (ASIC), or other hardware/software/firmware capable of providing the functionality described herein.

The computing device 1000 may include a variety of tangible processor-readable storage media and intangible processor-readable communication signals. Tangible processor-readable storage can be embodied by any available media that can be accessed by the computing device 1000 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information, and which can be accessed by the computing device 1000. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

One general aspect of the present disclosure includes a storage device. The storage device includes an FPGA device that has a programmable FPGA fabric. The FPGA device is in operative communication with a host device. The storage device also includes a plurality of storage controllers. Each of the plurality of storage controllers is in operative communication with a respective one of a plurality of memory devices for non-volatile storage of data in the plurality of memory devices. Each of the plurality of storage controllers are in operative communication with the FPGA device. The storage device also includes a storage resource that is accessible by the FPGA. The storage device stores one or more hardware execution functions for configuration of a data operation performed by the FPGA on data received by the FPGA device exchanged between the FPGA device and the plurality of storage controllers. The FPGA fabric is dynamically reconfigurable using the one or more hardware execution functions during operation of the storage device to provide one or more data operations on data at the FPGA device exchanged between the FPGA device and the storage controllers. The one or more data operations comprise parallel operation of each of the plurality of storage controllers of the storage device.

Implementations may include one or more of the following features. For example, the storage device may also include an enclosure containing the FPGA device, the plurality of storage controllers, and the plurality of memory devices. The enclosure may be engageable in a standard rack space of a storage rack chassis. Alternatively, the enclosure may comprise an appliance housing adapted to enclose the storage device.

In an example, the data operation includes at least one data management function performed by the FPGA device independent of the host device. In various examples, the at least one data management function may include one or more of storage tiering or RAID operations utilizing the plurality of memory devices. In some examples, the one or more data operations include at least one of a data flow management operation, a data acceleration operation, or an interface management operation for data performed in parallel by the FPGA device relative to data exchanged between the host and the plurality of storage controllers.

In an example, the storage resource may include a memory space of at least one of the plurality of memory devices.

In an example, the FPGA fabric may be dynamically reconfigurable during operation of the storage device to communicate using a plurality of different memory device interfaces. The FPGA fabric may be dynamically reconfigurable during operation of the storage device to communicate with the host device using a using a plurality of different memory device interfaces independent of a memory device interface of the plurality of memory devices.

Another general aspect of the present disclosure includes a method for operation of a computational storage device. The method includes establishing communication between an FPGA device comprising a programmable FPGA fabric and a host device. The method also includes establishing communication between the FPGA device and a plurality of storage controllers. The plurality of storage controllers are each in operative communication with a respective one of a plurality of memory devices for non-volatile storage of data in the plurality of memory devices. The method also includes retrieving, from a storage resource accessible by the FPGA, one or more hardware execution functions for configuration of a data operation performed by the FPGA fabric on data received by the FPGA device exchanged between the FPGA device and the plurality of storage controllers. The method includes dynamically configuring the FPGA fabric using the one or more hardware execution functions during operation of the storage device to provide one or more data operations on data at the FPGA device exchanged between the FPGA device and the storage controllers and applying the one or more data operations in parallel operations on data exchanged between the FPGA device and the storage controllers.

Implementations may include one or more of the following features. For example, the computational storage device may have an enclosure containing the FPGA device, the plurality of storage controllers, and the plurality of memory devices. In an example, the enclosure is engageable in a standard rack space of a storage rack chassis. In another example, the enclosure may comprise an appliance housing adapted to enclose the storage device.

In an example, the data operation may include at least one data management operation performed by the FPGA device independent of the host device. The at least one data management operation may include one or more of storage tiering or RAID operations utilizing the plurality of memory devices. Additionally or alternatively, the one or more data operations may include at least one of a data flow management operation, a data acceleration operation, or an interface management operation for data performed in parallel by the FPGA device relative to data exchanged between the host and the plurality of storage controllers.

In an example, the storage resource may be a memory space of at least one of the plurality of memory devices.

In an example, the FPGA fabric may be dynamically reconfigurable during operation of the storage device to communicate using a plurality of different communication interfaces. The FPGA fabric may be dynamically reconfigurable during operation of the storage device to communicate with the host device using a using a plurality of different communication interfaces independent of a memory device connection of the plurality of memory devices.

Another general aspect of the present disclosure includes one or more tangible processor-readable storage media embodied with instructions for executing on one or more processors and circuits of a device a process for operation of a computational storage device. The process includes establishing communication between an FPGA device comprising a programmable FPGA fabric and a host device. The process also includes establishing communication between the FPGA device and a plurality of storage controllers. Each of the plurality of storage controllers are in operative communication with a respective one of a plurality of memory devices for non-volatile storage of data in the plurality of memory devices. The process also includes retrieving, from a storage resource accessible by the FPGA, one or more hardware execution functions for configuration of a data operation performed by the FPGA fabric on data received by the FPGA device exchanged between the FPGA device and the plurality of storage controllers. The process includes dynamically configuring the FPGA fabric using the one or more hardware execution functions during operation of the storage device to provide one or more data operations on data at the FPGA device exchanged between the FPGA device and the storage controllers and applying the one or more data operations in parallel operations on data exchanged between the FPGA device and the storage controllers.

Implementations may include one or more of the following features. For example, the computational storage device may have an enclosure containing the FPGA device, the plurality of storage controllers, and the plurality of memory devices. The enclosure may be engageable in a standard rack space of a storage rack chassis. In another example, the enclosure may comprise an appliance housing adapted to enclose the storage device.

In an example, the data operation may include at least one data management operation performed by the FPGA device independent of the host device. For example, the at least one data management operation may include one or more of storage tiering or RAID operations utilizing the plurality of memory devices. In an example, the one or more data operations may include at least one of a data flow management operation, a data acceleration operation, or an interface management operation for data performed in parallel by the FPGA device relative to data exchanged between the host and the plurality of storage controllers.

In an example, the FPGA fabric may be dynamically reconfigurable during operation of the storage device to communicate using a plurality of different communication interfaces. The FPGA fabric is dynamically reconfigurable during operation of the storage device to communicate with the host device using a using a plurality of different communication interfaces independent of a memory device connection of the plurality of memory devices.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

What is claimed is:

1. A storage device, comprising:
an FPGA device comprising a programmable FPGA fabric, wherein the FPGA device is in operative communication with a host device;
a plurality of storage controllers, each in operative communication with a respective one of a plurality of memory devices for non-volatile storage of data in the plurality of memory devices, wherein each of the plurality of storage controllers are in operative communication with the FPGA device;
a storage resource, accessible by the FPGA, that stores one or more hardware execution functions for configuration of a data operation performed by the FPGA on data received by the FPGA device exchanged between the FPGA device and the plurality of storage controllers; and
wherein the FPGA fabric is dynamically reconfigurable using the one or more hardware execution functions during operation of the storage device to provide one or more data operations on data at the FPGA device exchanged between the FPGA device and the storage controllers, and wherein the one or more data operations comprise parallel operation of each of the plurality of storage controllers of the storage device.

2. The storage device of claim 1, further comprising:
an enclosure containing the FPGA device, the plurality of storage controllers, and the plurality of memory devices, and wherein the enclosure is engageable in a standard rack space of a storage rack chassis.

3. The storage device of claim 1, wherein the data operation comprises at least one data management function performed by the FPGA device independent of the host device.

4. The storage device of claim 3, wherein the at least one data management function comprises storage tiering or RAID operations utilizing the plurality of memory devices.

5. The storage device of claim 1, wherein the storage resource comprises a memory space of at least one of the plurality of memory devices.

6. The storage device of claim 1, wherein the one or more data operations comprise at least one of a data flow management operation, a data acceleration operation, or an interface management operation for data performed in parallel by the FPGA device relative to data exchanged between the host and the plurality of storage controllers.

7. The storage device of claim 1, wherein the FPGA fabric is dynamically reconfigurable during operation of the storage device to communicate using a plurality of different memory device interfaces, and wherein the FPGA fabric is dynamically reconfigurable during operation of the storage device to communicate with the host device using a using a plurality of different memory device interfaces independent of a memory device interface of the plurality of memory devices.

8. A method for operation of a computational storage device, the method comprising:
establishing communication between an FPGA device comprising a programmable FPGA fabric and a host device;
establishing communication between the FPGA device and a plurality of storage controllers each in operative communication with a respective one of a plurality of memory devices for non-volatile storage of data in the plurality of memory devices;
retrieving, from a storage resource accessible by the FPGA, one or more hardware execution functions for configuration of a data operation performed by the FPGA fabric on data received by the FPGA device exchanged between the FPGA device and the plurality of storage controllers;
dynamically configuring the FPGA fabric using the one or more hardware execution functions during operation of the storage device to provide one or more data operations on data at the FPGA device exchanged between the FPGA device and the storage controllers; and
applying the one or more data operations in parallel operations on data exchanged between the FPGA device and the storage controllers.

9. The method of claim 8, wherein the computational storage device comprises an enclosure containing the FPGA device, the plurality of storage controllers, and the plurality of memory devices, and wherein the enclosure is engageable in a standard rack space of a storage rack chassis.

10. The method of claim 8, wherein the data operation comprises at least one data management operation performed by the FPGA device independent of the host device.

11. The method of claim 10, wherein the at least one data management operation comprises storage tiering or RAID operations utilizing the plurality of memory devices.

12. The method of claim 8, wherein the storage resource comprises a memory space of at least one of the plurality of memory devices.

13. The method of claim 8, wherein the one or more data operations comprise at least one of a data flow management operation, a data acceleration operation, or an interface management operation for data performed in parallel by the FPGA device relative to data exchanged between the host and the plurality of storage controllers.

14. The method of claim 8, wherein the FPGA fabric is dynamically reconfigurable during operation of the storage device to communicate using a plurality of different communication interfaces, and wherein the FPGA fabric is dynamically reconfigurable during operation of the storage device to communicate with the host device using a using a plurality of different communication interfaces independent of a memory device connection of the plurality of memory devices.

15. One or more tangible processor-readable storage media embodied with instructions for executing on one or more processors and circuits of a device a process for operation of a computational storage device, comprising:
establishing communication between an FPGA device comprising a programmable FPGA fabric and a host device;
establishing communication between the FPGA device and a plurality of storage controllers each in operative communication with a respective one of a plurality of memory devices for non-volatile storage of data in the plurality of memory devices;
retrieving, from a storage resource accessible by the FPGA, one or more hardware execution functions for configuration of a data operation performed by the FPGA fabric on data received by the FPGA device exchanged between the FPGA device and the plurality of storage controllers;
dynamically configuring the FPGA fabric using the one or more hardware execution functions during operation of the storage device to provide one or more data operations on data at the FPGA device exchanged between the FPGA device and the storage controllers; and
applying the one or more data operations in parallel operations on data exchanged between the FPGA device and the storage controllers.

16. The one or more tangible processor-readable storage media of claim 15, wherein the computational storage device comprises an enclosure containing the FPGA device, the plurality of storage controllers, and the plurality of memory devices, and wherein the enclosure is engageable in a standard rack space of a storage rack chassis.

17. The one or more tangible processor-readable storage media of claim 15, wherein the data operation comprises at least one data management operation performed by the FPGA device independent of the host device.

18. The one or more tangible processor-readable storage media of claim 15, wherein the at least one data management operation comprises storage tiering or RAID operations utilizing the plurality of memory devices.

19. The one or more tangible processor-readable storage media of claim 15, wherein the one or more data operations comprise at least one of a data flow management operation, a data acceleration operation, or an interface management operation for data performed in parallel by the FPGA device relative to data exchanged between the host and the plurality of storage controllers.

20. The one or more tangible processor-readable storage media of claim 15, wherein the FPGA fabric is dynamically reconfigurable during operation of the storage device to communicate using a plurality of different communication interfaces, and wherein the FPGA fabric is dynamically reconfigurable during operation of the storage device to communicate with the host device using a using a plurality of different communication interfaces independent of a memory device connection of the plurality of memory devices.
